(19) United States
(12) Patent Application Publication
(10) Pub. No.: US 2011/0019881 A1
(43) Pub. Date: Jan. 27, 2011

(54) METHOD OF CREATING DICTIONARY FOR SOIL DETECTION OF A SHEET, SHEET PROCESSING APPARATUS, AND SHEET PROCESSING METHOD

(75) Inventor: Naotake Natori, Kunitachi-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/836,877

(22) Filed: Jul. 15, 2010

(30) Foreign Application Priority Data
Jul. 24, 2009 (JP) 2009-173504

(51) Int. Cl. G06K 9/00

(52) U.S. Cl. 382/112

(57) ABSTRACT

According to one embodiment, a method of creating a dictionary for soil detection of a sheet includes dividing a sensible area in first and second adjustment images into a plurality of areas, calculating a first characteristic amount of each divided area of the first adjustment image, calculating a second characteristic amount of each divided area of the second adjustment image, calculating a mean and a variance of the first and second characteristic amounts of each area, setting weight data for each area based on the calculated mean and variance, and storing the weight data together with threshold values for soil detection of a sheet.

### CROSS-REFERENCE TO RELATED APPLICATIONS

This application is based upon and claims the benefit of priority from Japanese Patent Application No. 2009-173504, filed Jul. 24, 2009; the entire contents of which are incorporated herein by reference.

### FIELD

Embodiments described herein relate generally to a method of creating a dictionary for soil detection of a sheet, a sheet processing apparatus using the dictionary, and a sheet processing method.

### BACKGROUND

A sheet processing apparatus for counting and discriminating various kinds of sheets including paper money has been practically used. A sheet processing apparatus takes in sheets one by one from an input unit, and conveys it to an inspection unit.

An inspection unit inspects a sheet in various aspects, and detects conditions of a sheet. Based on the result of inspection, a sheet processing apparatus checks each sheet for denomination, authentication, and fitness for recirculation.

A sheet processing apparatus determines a heavily soiled sheet to be unfit for recirculation (an unfit sheet). For this purpose, an inspection unit obtains an image from a conveyed sheet, compares the image with a preset reference value (a threshold value), and determines the soil level of the sheet.

For example, the sheet processing apparatus disclosed in U.S. Patent Application Publication US2006/0011447 A1 processes at least one fit sheet and one unfit sheet. The sheet processing apparatus saves obtained sensor data, and evaluates the saved data, thereby automatically adjusting a sensor threshold value. As a result, the sheet processing apparatus adapts to variation with time, and easily adjusts a sensor threshold value.

The sheet processing apparatus described in the above patent application evaluates a whole image obtained from a sheet, and adjusts a sensor threshold value.

A various patterns are formed by various methods on the surface of a sheet. Therefore, the surface of a sheet includes an area for printing with ink, an area for a watermark, and an area for a hologram.

In one or some of these areas, it is difficult to detect a soil level from the image of a sheet. For example, in an area with a large change in luminance, it is difficult to detect an axact soil level. This arises a problem in soil detection.

### BRIEF DESCRIPTION OF THE DRAWINGS

FIG. 1 is a diagram for explaining an example of configuration of a sheet processing apparatus according to an embodiment;

FIG. 2 is a view of an example of an image of a sheet to be processed by the sheet processing apparatus shown in FIG. 1;

FIG. 3 is a table for explaining dividing and weight adjustment of an image of a sheet;

FIG. 4 is a graph for setting a threshold value for soil detection;

FIG. 5 is a flowchart of creation of a dictionary in the sheet processing apparatus shown in FIG. 1;

FIG. 6 is a flowchart of soil detection in the sheet processing apparatus shown in FIG. 1; and

FIG. 7 is a table for explaining another example of weight adjustment.

### DETAILED DESCRIPTION

Various embodiments according to the invention will be described hereinafter with reference to the accompanying drawings. In general, according to one embodiment, a method of creating a dictionary for soil detection of a sheet includes dividing a sensible area in first and second adjustment images into a plurality of areas, calculating a first characteristic amount of each divided area of the first adjustment image, calculating a second characteristic amount of each divided area of the second adjustment image, calculating a mean and a variance of the first and second characteristic amounts of each area, setting weight data for each area based on the calculated mean and variance, and storing the weight data together with threshold values for soil detection of a sheet.

Hereinafter, by referring to the drawings, detailed explanation will be given of a method of creating a dictionary used in the sheet processing apparatus according to one embodiment, a sheet processing apparatus storing the dictionary, and a sheet processing method.

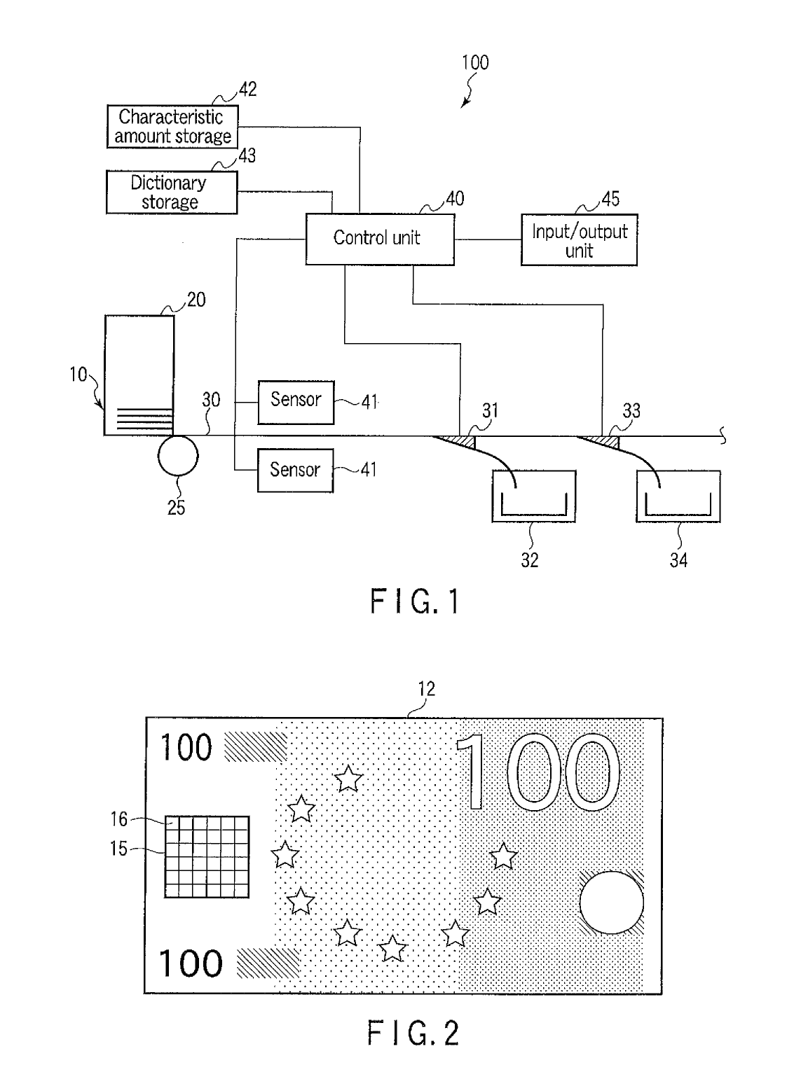

FIG. 1 is a diagram for explaining an example of configuration of a sheet processing apparatus 100 according to one embodiment.

The sheet processing apparatus 100 comprises a supply unit 20, a separation roller 25, a conveying system 30, a first gate 31, a first stacker 32, a second gate 33, a second stacker 34, a control unit 40, a sensor 41, a characteristic amount storage 42, a dictionary storage 43, and an input/output unit 45. The sheet processing apparatus 100 is also provided with a not-shown cutting unit in a stage subsequent to the second gate 33.

The control unit 40 comprehensively controls the operations of the components of the sheet processing apparatus 100. The control unit 40 comprises a CPU, a buffer memory, a program memory, and a nonvolatile memory. The CPU performs various arithmetic operations. The buffer memory temporarily stores the result of operations performed by the CPU. The program memory and nonvolatile memory store control data and various programs executed by the CPU. The control unit 40 can perform various operations by the CPU which executes the programs stored in the program memory.

The supply unit 20 stocks a sheet 10, which is taken into the sheet processing apparatus 100. The supply unit 20 accepts a stack of sheets 10.

The separation roller 25 is provided in the lower end of the supply unit 20. The separation roller 25 contacts the lower end of a stack of sheets 10. The separation roller 25 rotates, and takes the sheet 10 set in the supply unit 20 of the sheet processing apparatus 100, one by one from the lower end of the stack.

The separation roller 25 is takes out one sheet 10 by one rotation, for example. The separation roller 25 takes out the sheet 10 at a fixed pitch. The sheet 10 taken in by the separation roller 25 is led to the conveying system 30.

The conveying system 30 is a conveyer to convey the sheet 10 to each part of the sheet processing apparatus 100. The conveying system 30 comprises a conveyer belt and a drive pulley, which are not shown in the drawing. The conveying system 30 drives the drive pulley by a not-shown drive motor. The conveyer belt is driven by the drive pulley.

The conveying system 30 conveys the sheet 10 taken into by the separation roller 25 at a constant speed by the conveyer belt. In the conveying system 30, the part close to the separation roller 25 is assumed to be an upstream, and the opposite part is assumed to be a downstream, in the following description.

Two sensors 41 are opposed across the conveying system 30. The sensors 41 detect optical feature data of the sheet 10. In other words, the sensors 41 read images of both sides of the sheet 10 conveyed along the conveying system 30.

The sensors 41 function as an imaging unit. The sensors 41 take a two-dimensional image of the surface of the sheet 10. Each sensor 41 comprises a light-receiving element such as a charge coupled device (CCD), and an optical element. The sensor 41 emits light to the conveyed sheet 10, and receives reflected or transmitted light by the optical element. The sensor 41 images the light received by the optical element in the CCD, and obtains an electrical signal (an image).

The control unit 40 calculates a characteristic amount from the image taken by the sensor 41. The characteristic amount is a luminance value of each pixel, for example. In other words, the control unit 40 calculates characteristic amounts of the front and back of the sheet 10, based on the image taken by the sensor 41. The control unit 40 determines whether the sheet 10 is fit or unfit for recirculation, based on the calculated characteristic amount. Further, the control unit 40 detects the kind, front side/back side, and authentication of the sheet 10.

The first and second gates 31 and 33 are provided in the downstream of the sensor 41 in the conveying system 30. The first and second gates 31 and 33 are operated under the control of the control unit 40. The control unit 40 controls the first and second gates 31 and 33 according to the detection results of the sheet 10. The control unit 40 controls the gates to convey the sheet 10 to a predetermined processing unit.

The first gate 31 switches the conveying destination of the sheet 10 to the first stacker 32 or the second gate 33. The second gate 33 switches the conveying destination of the sheet 10 to the second stacker 34 or the cutting unit.

The control unit 40 controls the first gate 31 and second gate 33, so that the sheet 10 determined to be a fit sheet is conveyed to the first stacker 32 or second stacker 34. In other words, the control unit 40 controls each gate to classify and stack a fit sheet.

The control unit 40 controls the first gate 31 and second gate 33, so that the sheet 10 determined to be an unfit sheet is conveyed to the cutting unit provided in a stage subsequent to the second gate 33. In other words, the control unit 40 controls each gate to convey the sheet 10 determined to be an unfit sheet to the cutting unit, so that the cutting unit cuts the sheet.

The characteristic amount storage 42 stores the characteristic amount of the sheet 10 calculated by the control unit 40. The dictionary storage 43 stores the dictionary for soil detection.

The input/output unit 45 comprises an operation unit, and a display. The input/output unit 45 accepts operating instructions input by the user through the operation unit. The input/output unit 45 informs the user of various operation guides and operation results by displaying them on the display. The operation unit and display of the input/output unit 45 may be configured as a touch panel. In this case, the sheet processing apparatus 100 detects operating instructions by the buttons displayed in the input/output unit 45, and the operator's instructions.

In the soil detection, the control unit 40 determines whether the sheet 10 is a fit sheet or not, based on the soil level of the sheet 10 and the dictionary stored in the dictionary storage 43.

The dictionary contains weight data and threshold value for soil detection. In the soil detection (stain detection), the control unit 40 determines whether a sheet is soiled or not, based on the threshold value for soil detection (threshold value for stain detection). The control unit 40 determines whether the sheet 10 is a fit sheet or not, based on the weight data and the result of soil detection.

Therefore, the control unit 40 previously creates a dictionary. The dictionary creation process includes weight adjustment and threshold value setting. In other words, the control unit 40 performs the weight adjustment and threshold value setting, based on the characteristic amount stored in the characteristic amount storage 42.

In the dictionary creation process, the sheet processing apparatus 100 deals with a sheet previously determined to be a fit sheet (a first sheet) and a sheet previously determined to be an unfit sheet (a second sheet). In other words, the sensor 41 of the sheet processing apparatus 100 obtains a first adjustment image from a first sheet, and a second adjustment image from a second sheet.

FIG. 2 is a view of an example of an adjustment image 12 taken by the sensor 41 shown in FIG. 1.

When the adjustment image 12 is input from the sensor 41, the control unit 40 specifies a preset sensible area 15 on the image based on the instruction entered from the input/output unit 45. The control unit 40 divides the sensible area 15 into a plurality of divided areas 16 based on a preset size, by the instruction entered from the input/output unit 40. In this case, the control unit 40 functions as a divider.

The control unit 40 calculates a characteristic amount of each divided area 16, and stores the calculated characteristic amount in the characteristic amount storage 42. In this case, the control unit 40 functions as a calculator to calculate a characteristic amount.

In other words, the control unit 40 specifies the sensible area 15 in the first adjustment image. The control unit 40 divides the specified sensible area 15 into a plurality of divided areas 16. The control unit calculates a first characteristic amount of each divided area 16, and stores the calculated characteristic amount in the characteristic amount storage 42.

Further, the control unit 40 specifies the sensible area 15 in the second adjustment image. The control unit 40 divides the specified sensible area 15 into a plurality of divided areas 16. The control unit calculates a second characteristic amount of each divided area 16, and stores the calculated characteristic amount in the characteristic amount storage 42.

As a result, the characteristic amount storage 42 stores a first characteristic amount calculated from a fit sheet image, and a second characteristic amount calculated from an unfit sheet image, for each divided area 16. The number of fit sheet samples n₁ and the number of unfit sheet samples n₂, which are processed in the dictionary creation process, may be one or more.

First, the control unit 40 performs weight adjustment for setting the weight for each area. In the weight adjustment, the control unit 40 calculates the mean and variance of the characteristic amounts of the divided areas 16 of the samples stored in the characteristic amount storage 42. The following calculations are assumed to be done for each divided area 16 located at the same positions of the samples. In other words, the control unit 40 performs the calculations based on the characteristic amounts of the divided areas 16 corresponding to the samples.

The mean and variance are the average and variance of the characteristic amounts of the divided areas 16 located at the same positions of the samples. The control unit 40 individually calculates the mean and variance based on the first and second characteristic amounts. Assuming the first characteristic amount calculated from a fit sheet image to be x₁ᵢ, and the number of fit sheet samples to be n₁, the first mean μ₁ of the first characteristic amount can be expressed by the following formula 1.

$$First mean {μ}_{1} = \frac{{\sum }_{i = 1}^{{n}_{1}} {x}_{1 i}}{{n}_{1}} \qquad ( Formula 1 )$$

The first variance σ₁² of the first characteristic amount can be expressed by the following formula 2.

$$First variance {σ}_{1}^{2} = {\sum }_{i = 1}^{{n}_{1}} \frac{{( {x}_{1 i} - {μ}_{1} )}^{2}}{{n}_{1}} \qquad ( Formula 2 )$$

Assuming the second characteristic amount calculated from an unfit sheet image to be x₂ᵢ, and the number of unfit sheet samples to be n₂, the second mean μ₂ of the second characteristic amount can be expressed by the following formula 3.

$$Second mean {μ}_{2} = \frac{{\sum }_{i = 1}^{{n}_{2}} {x}_{2 i}}{{n}_{2}} \qquad ( Formula 3 )$$

The second variance σ₂² of the second characteristic amount can be expressed by the following formula 4.

$$Second variance {σ}_{2}^{2} = {\sum }_{i = 1}^{{n}_{2}} \frac{{( {x}_{2 i} - {μ}_{2} )}^{2}}{{n}_{2}} \qquad ( Formula 4 )$$

The control unit 40 calculates a within-class variance σ_{w}² and a between-class variance σ_{B}², based on the calculated mean and variance. The class indicates two kinds of sheet, a fit sheet and an unfit sheet. The within-class variance σ_{w}² can be expressed by the following formula 5.

$$Within \text{-} class variance {σ}_{w}^{2} = {σ}_{1}^{2} + {σ}_{2}^{2} \qquad ( Formula 5 )$$

A mean of the samples of first and second characteristic amounts of corresponding divided areas 16 is assumed to be M. The number of classes is assumed to be cl. An overall mean M can be expressed by the following formula 6.

$$Overall mean M = \frac{{\sum }_{j = 1}^{c 1} {\sum }_{i = 1}^{{n}_{j}} {x}_{ij}}{{\sum }_{j = 1}^{c 1} {n}_{j}} \qquad ( Formula 6 )$$

A between-class variance σ_{B}² can be expressed by the following formula 7.

$$Between \text{-} class variance {σ}_{B}^{2} = \frac{{\sum }_{j = 1}^{c 1} {{n}_{j} ( {μ}_{j} - M )}^{2}}{c 1} \qquad ( Formula 7 )$$

In this case, as the number of classes is two, cl=2.

Further, the control unit 40 calculates a reference c for each divided area 16, based on the within-class variance σ_{w}² and between-class variance σ_{B}². A reference c is calculated by the following formula 8.

$$Reference c = \frac{{σ}_{B}^{2}}{{σ}_{W}^{2}} \qquad ( Formula 8 )$$

The control unit 40 sets weight data of each divided area 16 based on the reference c. The reference c is a value obtained by dividing a between-class variance by a within-class variance. Therefore, as the reference c is larger, a variation in the characteristic amount of each sample is smaller. Namely, the control unit 40 determines a divided area 16 with a larger reference c to be suitable for soil detection.

The control unit 40 orders the divided areas based on the largeness of the reference value c. The control unit 40 sets weight W of each area as weight data, based on the order. Assuming the number of divided areas 16 to be m, the control unit 40 assigns order numbers 1 to m to the divided areas 16. The control unit determines Wₘ as weight data of each divided area 16. In other words, the control unit 40 sets the weight data Wₘ of the m-th divided area 16.

The control unit 40 selects N divided areas 16 with higher reference values c as areas used for soil detection, out of m divided areas 16, for example. The control unit 40 sets the weight Wₘ of a selected area to “1”, and sets the weight Wₘ of an unselected area to “0”.

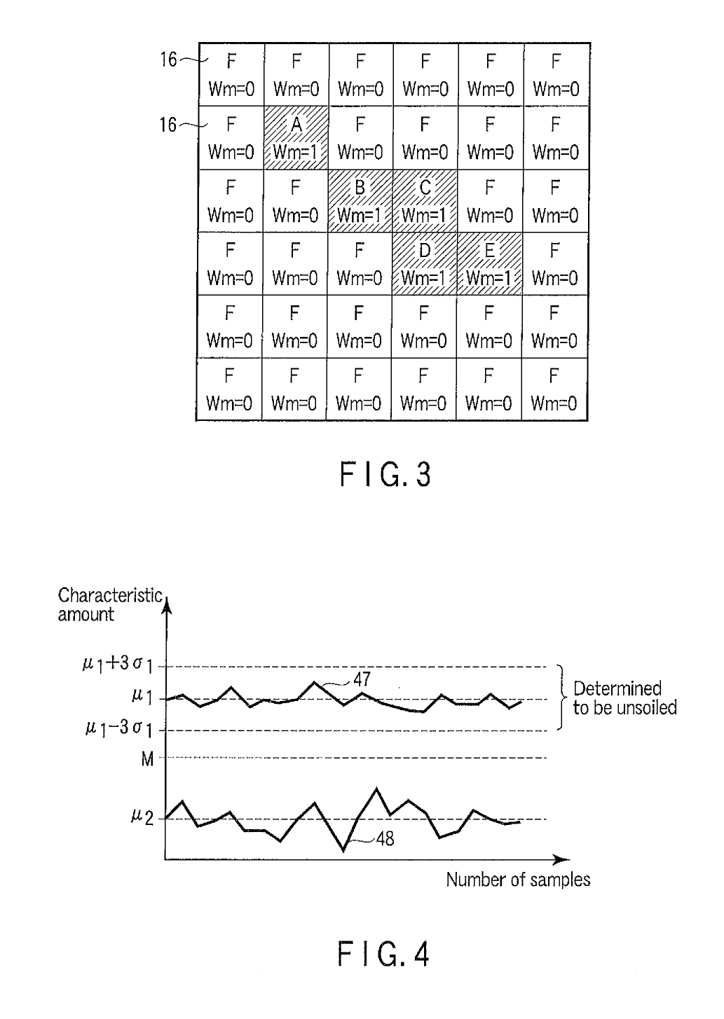

FIG. 3 is a table for explaining dividing and weight adjustment of the image of a sheet 10. Here, the control unit 40 selects hatched areas. In other words, the control unit 40 selects areas A to E as areas used for soil detection. The control unit 40 sets the weight W of areas A to E to “1”, and sets the weight W of the unselected area F to “0”.

Further, the control unit 40 sets a threshold value for soil detection of each divided area 16.

FIG. 4 is a graph for setting threshold values for soil detection.

The waveform 47 indicates a first characteristic amount (a characteristic amount of a fit sheet) of one of divided areas 16 in a plurality of samples. The waveform 48 indicates a second characteristic amount (a characteristic amount of an unfit sheet) of one of divided areas 16 in a plurality of samples. The control unit 40 sets a threshold value for soil detection of each divided area 16, based on the instruction entered from the input/output unit 45. For example, the control unit 40 sets a mean (a first mean) of first characteristic values μ₁+3σ₁ as a threshold value for soil detection.

The control unit 40 stores the threshold value for soil detection of each divided area 16, and the weight data of each divided area 16, as a dictionary, in the dictionary storage 43. The control unit 40 adds the data indicating the coordinates of each divided area 16 on an image, to a corresponding threshold value for soil detection and weight data, and stores the obtained data in the dictionary storage 43 as weight data.

In other words, the dictionary storage 43 stores the threshold value for soil detection of each divided area 16, weight data of each divide area 16, and data indicating the coordinates of each divide area 16.

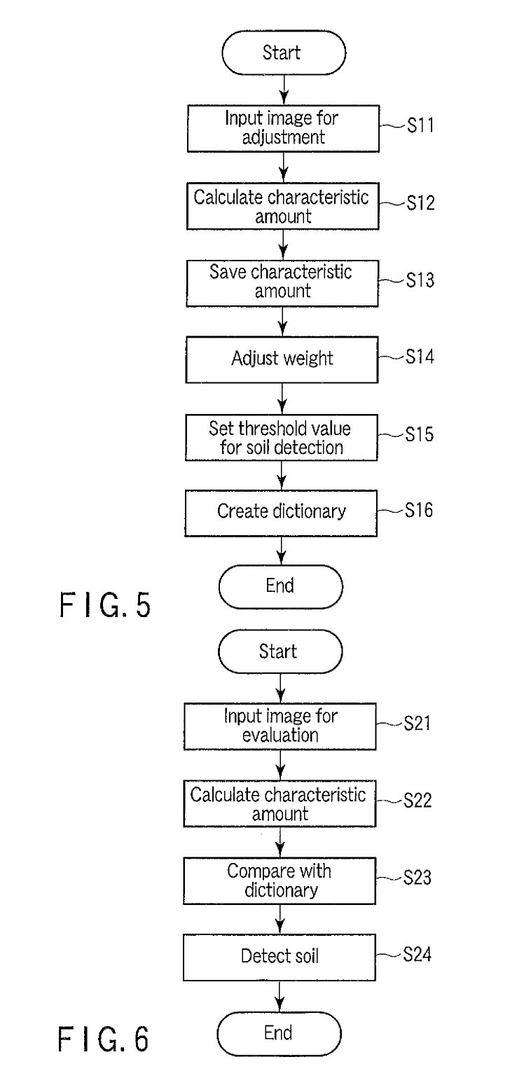

FIG. 5 is a flowchart of creation of a dictionary in the sheet processing apparatus 100 shown in FIG. 1.

First, the sheet processing apparatus 100 drives the separation roller 25, and takes in the sheet 100 set in the supply unit 20 one by one from the lower end of a stack. The sheet 10 set in the supply unit 20 consists of a first sheet previously determined to be a fit sheet, and a second sheet previously determined to be an unfit sheet.

The conveying system 30 conveys the sheet 10 to the sensor 41. The sensor 41 obtains the adjustment image 12 from the sheet 10, and sends the image to the control unit 40 (step S11). The sheet processing apparatus 100 individually processes the first and second sheets. In other words, the sensor 41 of the sheet processing apparatus 100 obtains a first adjustment image from a first sheet, and a second adjustment image from a second sheet.

When the adjustment image 12 is received from the sensor 41, the control unit 40 specifies the preset sensible area 15 on the image based on the instruction entered from the input/output unit 45. The control unit 40 divides the sensible area 15 into a plurality of divided areas 16 based on the preset size, based on the instruction entered from the input/output unit 45. The control unit 40 calculates the characteristic amount of each divided area 16 (step S12). The control unit 40 stores the calculated characteristic amounts in the characteristic amount storage 42 (step S13).

In other words, the control unit 40 divides the sensible area 15 of a first adjustment image into a plurality of divided areas 16. The control unit 40 calculates a first characteristic amount of each divided area 16, and stores the calculated characteristic amount in the characteristic amount storage 42.

The control unit 40 divides the sensible area 15 of a second adjustment image into a plurality of divided areas 16. The control unit 40 calculates a second characteristic amount of each divided area 16, and stores the calculated characteristic amount in the characteristic amount storage 42.

The control unit 40 performs weight adjustment for setting the weight of each area, based on the first and second characteristic amounts stored in the characteristic amount storage 42 (step S14). In other words, the control unit 40 calculates the mean and variance of the characteristic amounts of the divided areas 16 of the samples. The control unit 40 sets a weight Wₘ as weight data for each divided area 16.

The control unit 40 sets a threshold value for soil detection of each divided area 16 (step S15).

The control unit 40 creates a dictionary from the threshold value for soil detection of each divided area 16, and the weight data of each divided area 16, and stores the dictionary in the dictionary storage 43 (step S16).

As described above, according to the method of creating a dictionary according to this embodiment, the control unit 40 divides an image into a plurality of areas, and calculates a characteristic amount of each divided area. The control unit 40 sets weight data for each area based on the mean and variance of the calculated characteristic amounts. Further, the control unit 40 sets a threshold value for soil detection in each area. The control unit 40 creates a dictionary based on the weight data and threshold value for soil detection, and stores the dictionary in the dictionary storage 43.

This makes it possible to specify an area suitable for soil detection. The degree of importance in soil detection can be set for each area. As a result, it is possible to provide a method of creating a dictionary for soil detection used for accurate soil detection of a sheet.

Next, soil detection will be explained.

FIG. 6 is a flowchart of soil detection in the sheet processing apparatus shown in FIG. 1.

In the soil detection, the sheet processing apparatus 100 processes the sheet 10 to be evaluated. In other words, the sensor 41 of the sheet processing apparatus 100 obtains an evaluation image from the sheet 10 for evaluation. The sensor 41 sends the obtained evaluation image to the control unit 40 (step S21).

When the evaluation image is received from the sensor 41, the control unit 40 specifies a preset sensible area 15 on the image based on the instruction entered from the input/output unit 45. The control unit 40 divides the sensible area 15 into a plurality of divided areas 16 based on a preset size, based on the instruction entered from the input/output unit 45. The control unit 40 calculates a characteristic amount (a characteristic amount for evaluation) of each divided area 16 (step S22). In other words, the calculator 40 calculates a characteristic amount for evaluation for each divided area 16 of the sensible area 15 of the sheet 10 for evaluation.

The control unit 40 compares the calculated characteristic amount for evaluation with the dictionary stored in the dictionary storage 43 (step S23). In other words, the control unit 40 determines whether each divided area 16 is soiled or not, based on the calculated characteristic amount for evaluation and the threshold value for soil detection stored in the dictionary storage 43. In this case, the control unit 40 functions as a soil detection unit.

In other words, the control unit 40 determines whether the calculated characteristic amount for evaluation falls in a range of threshold values for soil detection (μ₁−3σ₁ to μ₁+1σ₁). When the calculated characteristic amount for evaluation falls in the range of μ₁−3σ₁ to μ₁+3σ₁, the control unit 40 determines that the corresponding divided area 16 is unsoiled. When the calculated characteristic amount for evaluation does not fall in the range of μ₁−3σ₁ to μ₁+3σ₁, the control unit 40 determines that the corresponding divided area 16 is soiled.

The control unit 40 determines the result yₘ of soil detection for each of m divided areas 16. In other words, the control unit 40 determines the result yₘ of soil detection for each m-th divided area 16.

For example, the control unit 40 sets “1” for the result of soil detection yₘ of an unsoiled area, and “0” for the result yₘ of a soiled area.

The control unit 40 determines whether the sheet 10 is a fit sheet or an unfit sheet, based on the weight Wₘ of each divided area 16 stored in the dictionary storage 43, and the result of soil detection yₘ for each divided area 16 (step S24). In this case, the control unit 40 functions as a soil detection unit.

The control unit 40 multiplies the weights Wₘ by yₘ for each area, and obtains the product Wₘyₘ for each area. The control unit 40 compares the value obtained by adding the values Wₘyₘ of m areas, with a preset threshold value for soil detection θ.

For example, when the following formula 9 is satisfied, the control unit 40 determines the sheet 10 to be a fit sheet.

$${\sum }_{m} {W}_{m} {y}_{m} > θ \qquad ( Formula 9 )$$

When the following formula 10 is satisfied, the control unit 40 determines the sheet 10 to be an unfit sheet.

$${\sum }_{m} {W}_{m} {y}_{m} \leq θ \qquad ( Formula 10 )$$

The threshold value for soil detection 8 is a threshold value for final decision. The control unit 40 stores the threshold value for soil detection 0 in a storage such as a memory. The threshold value for soil detection θ is previously set to a desired value based on the instruction entered from the input/output unit 45. Assuming yₘ to be “0” or “1”, the threshold value for soil detection θ can be freely set within a range of the following formula 11

$$0 \leq θ \leq {\sum }_{m} {W}_{m} \qquad ( Formula 11 )$$

Assuming yₘ to be “0” to “yₘₐₓ”, the threshold value for soil detection θ can be freely set within a range of the following formula 12

$$0 \leq θ \leq {\sum }_{m} {W}_{m} {y}_{max} \qquad ( Formula 12 )$$

Σ_{y} corresponds to the number of areas determined to be unsoiled. For example, there are ten areas where yₘ is “1” or “0”, the threshold value for soil detection θ is “5”, and the weight Wₘ is “1”. When six or more of the ten areas are determined to be unsoiled, the control unit 40 determines the sheet 10 to be a fit sheet. In other words, the higher the threshold value for soil detection θ, the severer soil detection is possible.

As described above, the sheet processing apparatus 100 according to the embodiment divides an image into a plurality of areas, and calculates a characteristic amount of each divided area. The control unit 40 compares the characteristic amount of each divided area, with a threshold value for soil detection stored in a dictionary, and determines whether each area is soiled or not. The control unit 40 determines whether the sheet 10 is a fit sheet or an unfit sheet, based on the result of soil detection in each area, and the weight data in the dictionary.

Therefore, soil detection can be performed by differentiating the result of soil detection in each area. This makes it possible to provide a sheet processing apparatus capable of detecting soil of a sheet with higher accuracy, and a sheet processing method.

In the embodiment described hereinbefore, the control unit 40 sets “1” for the weight data Wₘ of an area selected for soil detection, and “0” for the weight data Wₘ of an unselected area. The weight data setting is not limited to this. For example, the weight Wₘ may be set in stages according to the importance of area.

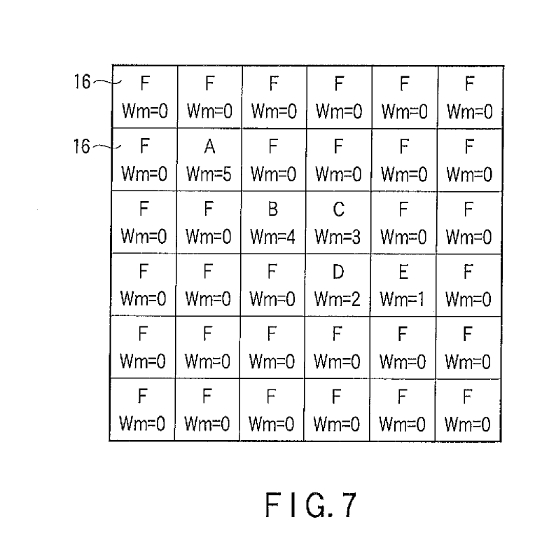

FIG. 7 is a table for explaining another example of weight adjustment. In the example shown in FIG. 7, the control unit 40 sets weight data in stages for each divided area 26.

The control unit 40 selects areas A to E. In other words, the control unit 40 selects N=5 divided areas 16 for soil detection.

The order of reference c for each area is set to “reference c for area A>reference c for area B>reference c fore area C>reference c for area D>reference c for area E”.

Assuming the order of the reference c for each area to be rᵢ, the control unit 40 sets the weight data Wᵢ of each area based on the following formula 13.

Wᵢ=N−(rᵢ−1) (Formula 13)

In other words, the control unit 40 sets “5” for the weight data W of area A, “4” for the weight data of area B, “3” for the weight data of area C, “2” for the weight data of area D, “1” for the weight data of area E, and “0” for the weight data of area F.

According to the above configuration, the sheet processing apparatus 100 can perform soil detection particularly based on the result of soil detection in a selected area.

In the embodiment described above, the control unit 40 sets the mean of first characteristic amounts “μ₁+3σ₁” to be a threshold value for soil detection. A threshold value is not limited to this. Any characteristic amount may be set as a threshold value for soil detection.

Further, the control unit 40 may be configured to set an intermediate threshold value and a range of threshold values for soil detection, not to set upper and lower limit of a threshold value for soil detection. In this case, the control unit 40 sets “μ₁” for an intermediate threshold value for soil detection, and “3σ₁” for a range of threshold values, as an dictionary.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of creating a dictionary for soil detection of a sheet, comprising:
dividing a sensible area in first and second adjustment images into a plurality of areas;
calculating a first characteristic amount of each divided area of the first adjustment image;
calculating a second characteristic amount of each divided area of the second adjustment image;
calculating a mean and a variance of the first and second characteristic amounts of each area;
setting weight data for each area based on the calculated mean and variance; and
storing the weight data together with threshold values for soil detection of a sheet, for said each area.

2. The method of creating a dictionary for soil detection of a sheet according to claim 1, further comprising:
calculating a within-class variance and a between-class variance based on the mean and variance of the first and second characteristic amounts; and
setting weight data for each area based on the ratio between the calculated within-class variance and between-class variance.

3. The method of creating a dictionary for soil detection of a sheet according to claim 2, further comprising:
determining the order of each area based on the ratio between the calculated within-class variance and between-class variance; and
setting weight data for each area based on the determined order.

4. The method of creating a dictionary for soil detection of a sheet according to claim 3, further comprising:
setting weight data in stages for each area based on the determined order.

5. The method of creating a dictionary for soil detection of a sheet according to claim 4, further comprising:
determining the order of each area in descending order of the values obtained by dividing the between-class variance by the within-class variance; and
setting the values of weight data in descending order.

6. The method of creating a dictionary for soil detection of a sheet according to claim 5, further comprising:
setting the weight data of an area without a watermark to a higher value.

7. A sheet processing apparatus comprising:
a dictionary storage configured to previously store a
dictionary containing weight data and threshold values for soil detection to determine whether each area is soiled or not;
a conveying system configured to convey a sheet;
an imaging unit configured to receive light from a sheet conveyed along the conveying system, and takes an image for evaluation;
a dividing unit configured to divide a sensible area in the image for evaluation taken by the imaging unit;
a calculation unit configured to calculate a characteristic amount for evaluation of each divided area of the image for evaluation;
a stain detection unit configured to detect stain in each area based on the characteristic amount for evaluation calculated by the calculation unit, and the threshold values for soil detection contained in the dictionary stored in the dictionary storage; and
a soil detection unit configured to detect soil of the sheet based on the result of stain detection for each area determined by the stain detection unit, and the weight data contained in the dictionary stored in the dictionary storage.

8. The sheet processing apparatus according to claim 7, wherein the soil detection unit previously stores threshold values for soil detection of the sheet, weights the result of stain detection for each area determined by the stain detection unit by weight data, and detects soil of the sheet based on the weighted result and the threshold values for soil detection.

9. A sheet processing method comprising:
conveying a sheet;
receiving light from the conveyed sheet, and taking an image for evaluation;
dividing a sensible area in the image for evaluation into a plurality of areas;
calculating a characteristic amount for evaluation of each divided area of the image for evaluation;
detecting stain in each area based on the calculated characteristic amount for evaluation, and previously stored threshold values for soil detection of each divided area; and
detecting soil of the sheet based on the result of stain detection for each area, and previously stored weight data.
